(19) United States
(12) Patent Application Publication
(10) Pub. No.: US 2008/0099292 A1
(43) Pub. Date: May 1, 2008

(54) OVERRUNNING BI-DIRECTIONAL CLUTCH WITH SPRAG ELEMENTS

(75) Inventor: Brian Lee, York, SC (US)

Correspondence Address: LUCAS & MERCANTI, LLP, 475 PARK AVENUE SOUTH, 15TH FLOOR, NEW YORK, NY, 10016, US

(73) Assignee: SCHAEFFLER KG, Herzogenaurach (DE)

(21) Appl. No.: 11/923,849

(22) Filed: Oct. 25, 2007

Related U.S. Application Data
(60) Provisional application No. 60/854,528, filed on Oct. 26, 2006.
(60) Provisional application No. 60/876,651, filed on Dec. 22, 2006.

(51) Int. Cl. F16D 13/06

(52) U.S. Cl. 192/43

(57) ABSTRACT

The overrunning bi-directional clutch uses sprags to increased torque and decreased size of the clutch.

### FIELD OF INVENTION

This invention relates to overrunning bi-directional clutches and, more particularly, to an improved design for the roller elements in the clutch.

### BACKGROUND OF THE INVENTION

Overrunning bi-directional clutches are known, see for example U.S. Pat. Nos. 6,409,001; 7,004,875; and 7,037,200. Such clutches are mounted between two coaxial shafts and are used to transfer power between the two shafts. The clutch is fixed to a first shaft and selectively engages the second shaft so as to transfer power between the two shafts. Typically, the first shaft is the power input shaft and typically, the first shaft is also the inner shaft of the two shafts. The output shaft or second shaft can be a geared wheel.

Overrunning bi-directional clutches comprise a fixed ring, a slipper ring, cylindrical rollers which are housed between the two rings and may have an actuator. The fixed ring and the slipper ring are coaxial cylindrical rings with opposing faces. Each of the opposing faces has concave bearing surfaces which define pockets. Each pocket houses a roller.

The slipper ring has an axial groove or slit that extends both radially and axially through the ring. The slit allows the slipper ring to move radially under force and the memory inherent in the material from which the slipper ring is made allows the ring to return to a rest position once the force is withdrawn. The fixed ring is mounted onto the first shaft while the slipper ring is spaced in close proximity to the second shafts such that when the slipper ring moves radially, it engages the second shaft, thereby transferring power between the two shafts. Once the force is removed from the slipper ring, it returns to its rest position and no longer engages the second shaft.

The actuator is used to maintain the clutch in the freewheel mode and to move the clutch to the lock mode. Typically, the actuator is a radial mounted moveable pin which is fixed to the fixed rings and retractable from the slipper ring. When the actuator engages both rings the two rings are coupled and the clutch is in the freewheel mode. In the freewheel mode, the opposing concave bearing surfaces are aligned with each other and the rollers rest in the bottom of each of the opposing concave surfaces. When the actuator pin is withdrawn from the slipper ring, the two rings move relative to one another and the rollers move out of the bottom of the opposing concave surfaces and rise up along diagonally opposing surfaces of the pocket so as to force the slipper ring to move radially and to engage the second shaft, thereby transferring power between the two shafts, locking the clutch and placing the clutch in the lock mode.

One of the problems with overrunning bi-directional clutches is that the torque capacity of the clutch is limited by the cylindrical rollers. Additionally, the use of cylindrical rollers limits the size of the clutch.

### OBJECT OF THE INVENTION

It is the object of the invention to increase the torque capacity of bi-directional clutches. It is a further object of the present invention to provide a smaller sized clutch which can handle the same torque as a larger sized clutch.

These and other objectives of the present invention will become more readily apparent by reference to the following description of the invention.

### SUMMARY OF THE INVENTION

The objects of the invention are achieved by using sprags in place of the cylindrical rollers. Suitably, the sprags have a figure eight cross section taken along their longitudinal axis and are symmetrical at least side-to-side. More preferably, the sprags used in the present invention are symmetrical from top-to-bottom as well as side-to-side. When the sprag is symmetrical top-to-bottom and side-to-side, each sprag has a top radius equal to the bottom radius and two radius are concentric.

The use of sprags allows the bearing surface of the fixed ring and slipper ring to be smooth, without a plurality of concave surfaces, thereby simplifying the design. The use of sprags also allows one of the bearing surfaces to be smooth while the other bearing surface is concave. Sprags also allow both bearing surfaces to be concave.

Broadly, the present invention is:

an overrunning bi-directional clutch for transferring power between a first and second coaxial shaft, comprising:
(a) a cylindrical slipper ring having a first radial surface for frictional engagement with said second shaft, and a second radial surface having a bearing surface thereon;
(b) a cylindrical fixed bearing surface affixable to said first shaft, said fixed bearing surface coaxial with said slipper ring and said fixed bearing surface radially opposing the bearing surface of said slipper ring; and
(c) sprags positioned between the bearing surface of said slipper ring and said fixed bearing surface.

The rotational forces allow the sprags to rock diagonally and force the slipper ring to engage the first shaft and place the clutch in the lock mode. When the rotational forces stop, shafts stop rotating, the memory inherent in the slipper ring pulls the sprag down, out of their canted position and places the clutch into the freewheel mode.

Preferably, the clutch has an actuator at said fixed bearing surface and movably engageable with said slipper ring, to couple said slipper ring to said fixed surface bearing and disengageable from said slipper ring to uncouple said slipper ring from said fixed bearing surface and cause the sprags to rock diagonally against the bearing surface of the slipper ring and the fixed bearing surface thereby applying a radial force to said slipper ring.

Preferably, the first shaft is the inner shaft while the second shaft is the outer shaft. The fixed bearing surface can be on an outer surface of the first shaft or an outer surface of a fixed cylindrical ring. In the case of a fixed cylindrical ring, the fixed cylindrical ring has a first radial surface affixable to the first shaft and a second radial surface which acts as the fixed bearing surface.

The bearing surface of the slipper ring and the fixed bearing surface can both be smooth, or one can be smooth and the other can be a plurality of concave bearing surfaces; or both can be a plurality of concave bearing surfaces. When both bearing surfaces have a plurality of concave bearing surfaces, each of the plurality of concave bearing surfaces of the slipper ring radially oppose a corresponding concave bearing surface on the fixed bearing surface so as to form a plurality of pockets and the sprags housed in these pockets.

Suitably, the sprags employ a cage to hold the sprags in position, however, a cage is not necessary if the sprags are in intimate contact or if a pocket is used on the bearing surfaces. The pocket will maintain the position of the sprag therein. Furthermore, it will be noted that no spring is needed to maintain the orientation of the sprag when the sprags are in intimate contact or when pockets are used to hold the sprags. The pockets themselves maintain the orientation of the sprag and the spring inherent in the slipper ring acts to hold the sprags which are in intimate contact. The shift of the slipper ring relative to the fixed bearing surface in conjunction with the movement of the sprags provide the radial force which result in the movement of the slipper ring and its engagement with the first shaft.

These and other aspects of the present invention will become more readily apparent by reference to one or more of the following drawings.

### BRIEF DESCRIPTION OF THE DRAWINGS

FIG. 1 illustrates a partial view of the overrunning bi-directional clutch of the present invention;

FIG. 2 illustrates a conventional overrunning bi-directional clutch using roller elements;

FIGS. 3A and 3B illustrates a complete overrunning bi-directional clutch of the present invention;

FIG. 4 is a detailed view of a section of a clutch of FIG. 3 with the sprags at rest;

FIG. 5 illustrates the present invention where the sprags have made contact with the rings to apply radial force against the slipper ring;

FIGS. 6A, 6B and 6C illustrates a symmetrical sprag for the present invention in freewheel mode; and

FIGS. 7A, 7B and 7C illustrates asymmetrical sprag in accordance with the present invention in lock mode.

### DETAILED DESCRIPTION OF THE DRAWINGS

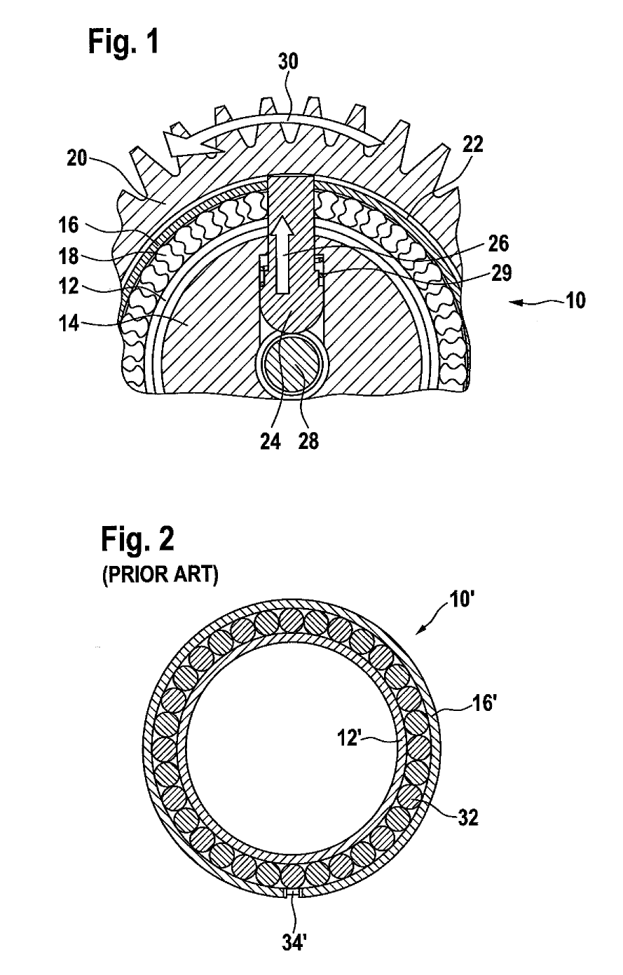

FIG. 1 illustrates a partial view of overrunning bi-directional clutch 10 of the present Invention having fixed ring 12 which is fixed to inner shaft 14 and slipper ring 16 with sprags 18 positioned there between. Outer shaft 20 is shown as a geared wheel. Clearance 22 is the distance between outer shaft 20 and slipper ring 16. Actuator 24 is shown engaging both slipper ring 16 and fixed ring 12 so as to couple ring 12 to ring 16. Arrow 26 indicates the force applied by actuator cam 28 to maintain the coupling of rings 12 and 16. Upon movement of actuator cam 28 to remove the upward force against actuator 24, spring 29 moves actuator 24 downward in a direction opposite arrow 26 and causes slipper ring 16 to become uncoupled from fixed ring 12. This uncoupling allows slipper ring 16 to lag behind the direction of rotation of fixed ring 12 and causes sprags 18 to rotate thereby forcing slipper ring 16 outward and into engagement with outer shaft 20. For illustration purposes, arrow 30 shows the direction of rotation of inner shaft 14.

It will be noted that sprag 18 is a symmetrical sprag.

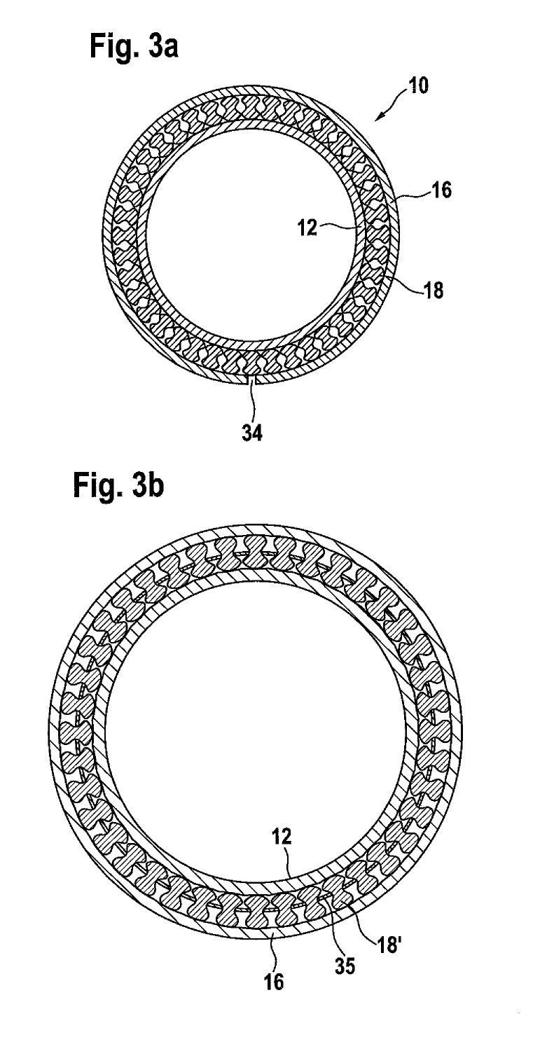

One of the novel aspects of the present invention is illustrated by comparing FIGS. 2 and 3A. FIGS. 2 and 3A each have the same diameter slipper ring, labeled 16 and 16′, and the same diameter fixed ring, labeled 12 and 12′. Clutch 10′ in FIG. 2 uses roller elements 32 and the annular space between fixed ring 12′ and slipper ring 16′ houses thirty-four (34) roller elements 32. In contrast, clutch 10, shown in FIG. 3A, employs 40 sprag elements 18 in the annular space between fixed ring 12 and slipper ring 16. For purposes of illustration, axial groove 34, 34′ is shown in slipper ring 16 and 16′. As can be seen, the number of sprags 18 is greater than the number of roller elements 32. This allows clutch 10 of the present invention to handle a higher torque than clutch 10′ employing the roller elements even though the diameters of their respective fixed rings and slipper rings are the same. This also means that a smaller diameter fixed ring and slipper ring can be employed with the number of sprags 18 equal to the number of rollers because sprags 18 take up less space than rollers 32.

FIG. 3B is the same as FIG. 3A except cage 35 to hold sprag 18′. Cage 35 is a conventional sprag cage.

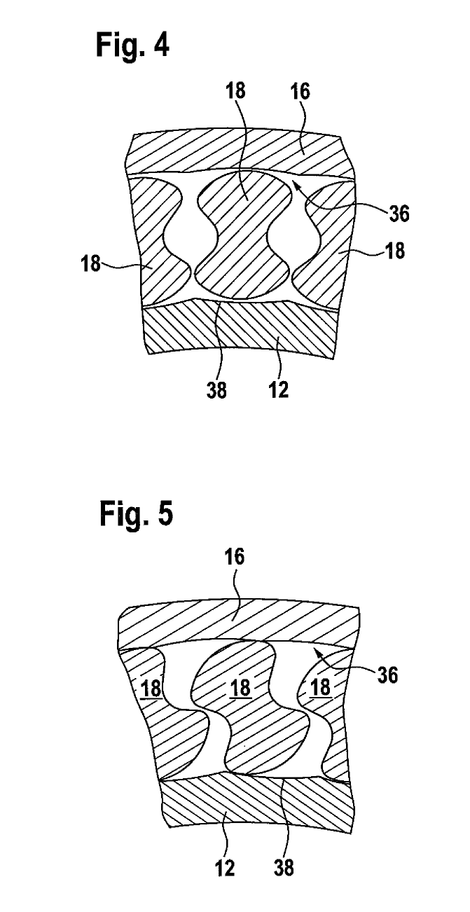

FIG. 4 illustrates clutch 10 of the present invention wherein slipper ring 16 and fixed ring 12 are coupled by actuator 24. As illustrated, fixed ring 12 has concave bearing surfaces 38 and slipper ring 16 has concave bearing surfaces 36. As can be seen, sprags 18 rest in the bottom of concave surfaces 36 and 38 when actuator 24 couples fixed ring 12 to slipper ring 16.

FIG. 5 illustrates the positions of sprags 18 when actuator 24 uncouples slipper ring 16 from fixed ring 12. As can be seen, slipper ring 16 lags behind fixed ring 12. The sides of the concave bearing surfaces 36 and 38 cause sprags 18 to rock and thereby apply a radial force between rings 12 and 16. Because slipper ring 16 has axial groove 34 and has clearance 22 between slipper ring 16 and outer shaft 20, slipper ring 16 expands radially outward to make contact with outer shaft 20. This frictional contact between slipper ring 16 and outer shaft 20 binds outer shaft 20 to inner shaft 14 thereby allowing for power to be transmitted between the two shafts. This action is similar to the rollers employing conventional overrunning bi-directional clutches, however, it provides a saving of space and higher packing of elements between the fixed ring and the slipper ring thereby resulting in an improvement to conventional overrunning bi-directional clutches.

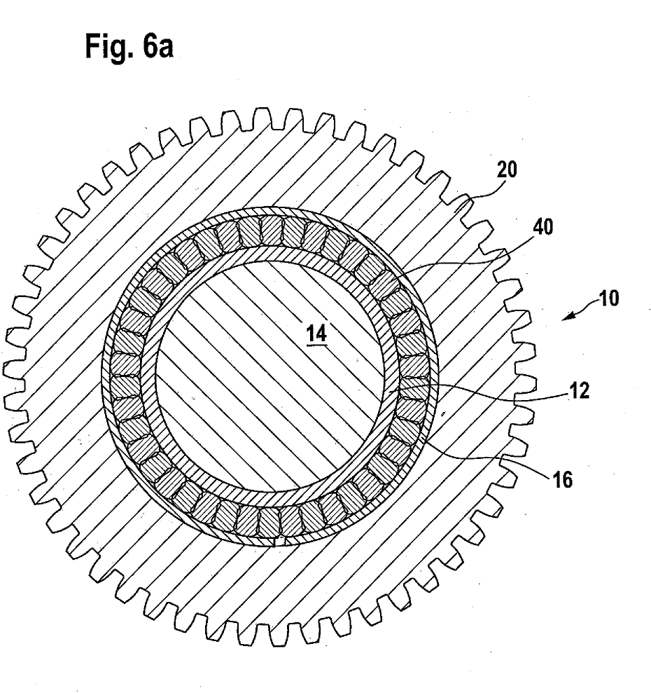

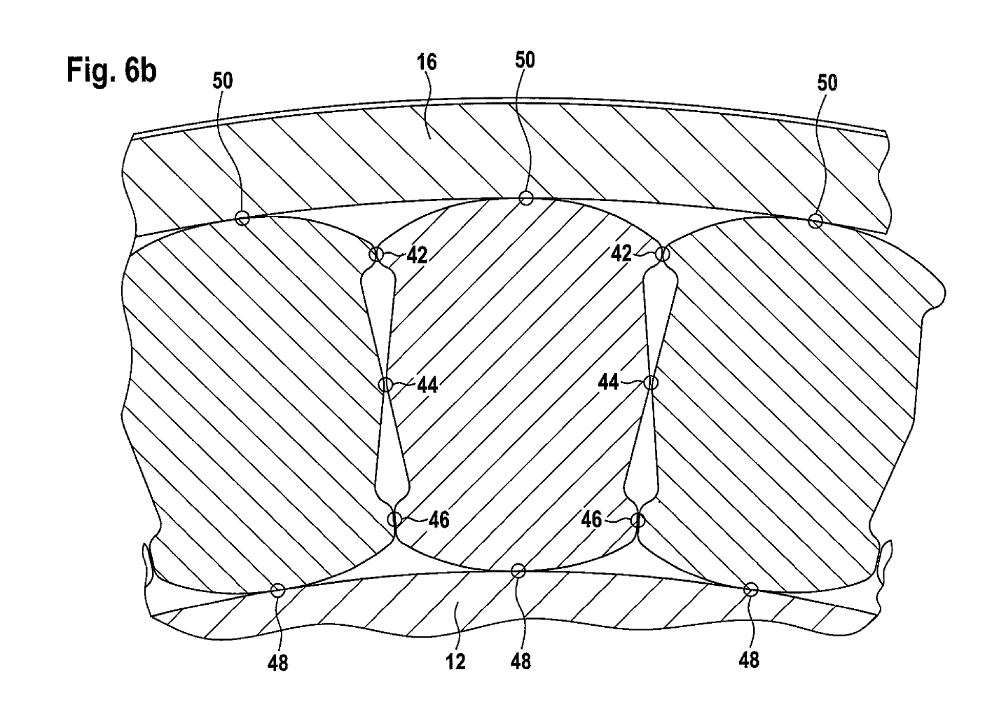

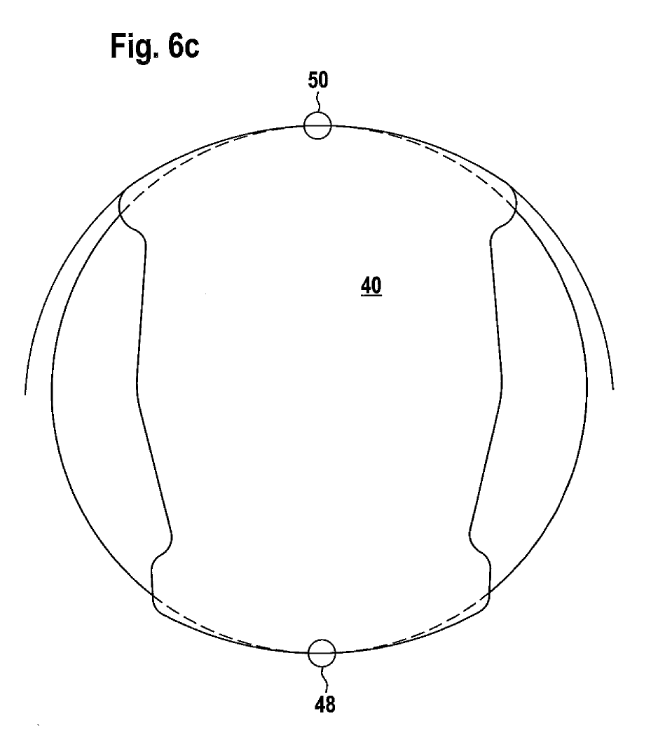

FIGS. 6A-6C illustrate asymmetrical sprag 40 when clutch 10 is in the freewheel mode and the sprags in intimate contact. FIG. 6B illustrates contact points 42, 44 and 46 between each sprag 40 and contact points 48 and 50 illustrate contact points between bearing surfaces of ring 12 and 16. FIG. 6C illustrates the maximum radial length of sprag 40 in freewheel mode. FIGS. 6A and 6B illustrate fixed ring 12 and slipper ring 16 with smooth bearing surfaces. As should be appreciated, the bearing surface of fixed ring 12 can be formed directly on the outer surface of inner shaft 14.

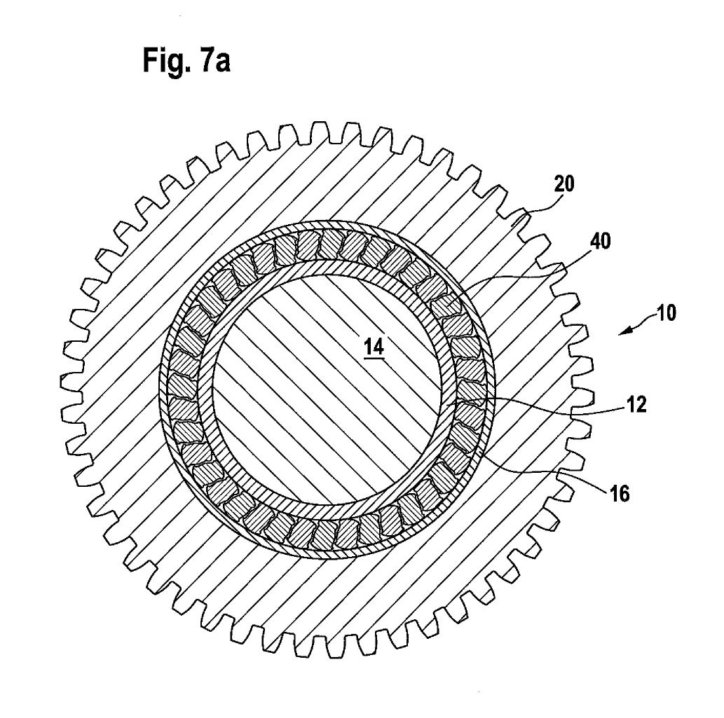

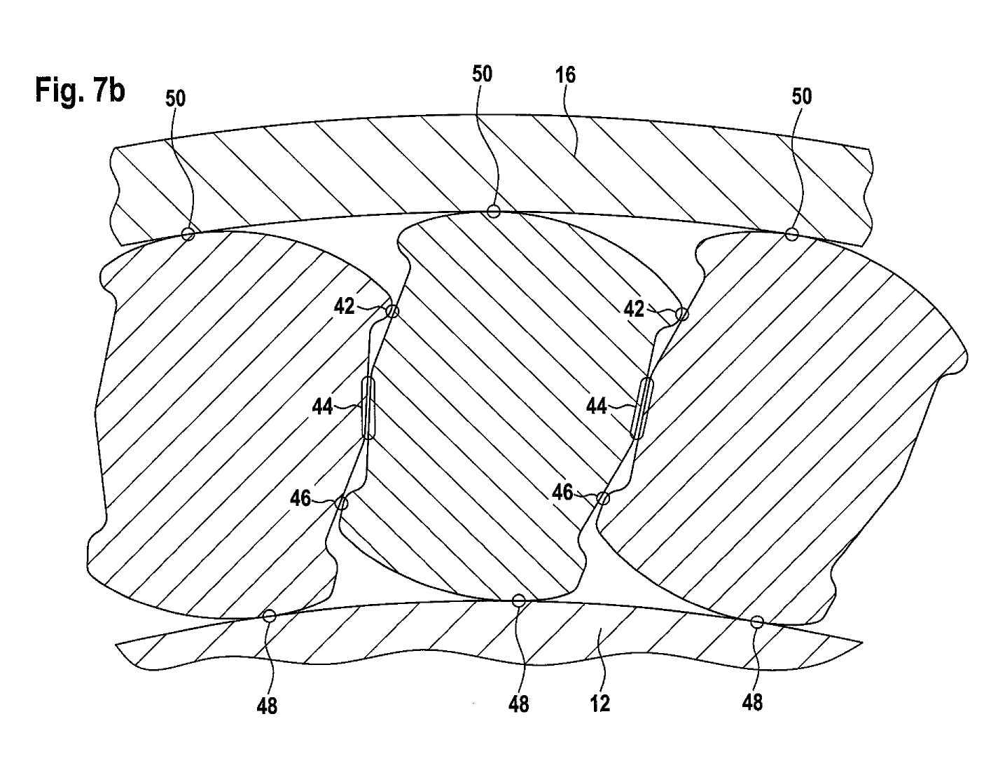

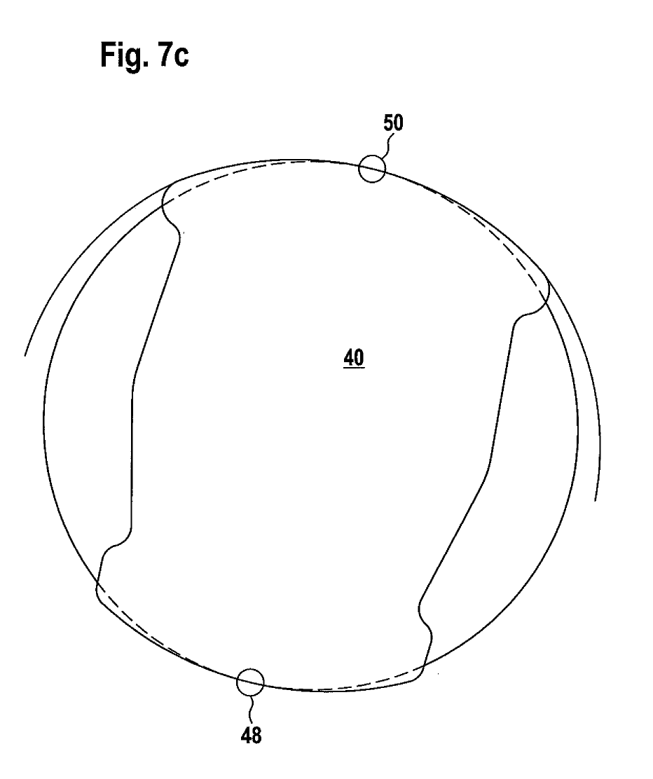

FIG. 7A-7C illustrate asymmetrical sprag 40 when clutch 10 is in the lock mode. FIG. 7B illustrates the shift of each contact point 42-50 and FIG. 7C illustrates the increase in radial length of sprag 40 due to the shift of sprag 40.

Contact points 42-50 of sprag 40 causes the sprags to rock and shift, maintains the orientation of the sprags and avoids the need for a cage or pockets to maintain the orientation and cause outward radial movement of slipper ring 16.

It will be appreciated that the concave bearing surface can be curved as illustrated or be an acute angle such that the sides of the concave surface are flat and not curved.

### REFERENCE CHARACTERS

10′ 10 clutch
12′ 12 fixed ring
14 inner shaft
16′ 16 slipper ring
18′ 18 sprags
20 outer shaft
22 clearance
24 actuator
26 arrow
28 actuator cam
29 spring
30 arrow
32 roller elements
34′ 34 axial groove
35 cage
36 concave bearing surfaces
38 concave bearing surfaces
40 sprag
42 contact point
44 contact point
46 contact point
48 contact point
50 contact point

I claim:

1. An overrunning, bi-directional clutch for transferring power between a first and second coaxial shaft comprising:
(a) a cylindrical slipper ring having a first radial surface for frictional engagement with said second shaft, and a second radial surface having a bearing surface thereon;
(b) a cylindrical fixed bearing surface affixable to said first shaft, said fixed bearing surface coaxial with said slipper ring and said fixed bearing surface radially opposing said bearing surface of said slipper ring; and
(c) sprags positioned between said bearing surface of said slipper ring and said fixed bearing surface.

2. The clutch of claim 1 further comprising:
an actuator at said fixed bearing surface and movably engagable with said slipper ring, to couple said slipper ring to said fixed bearing surface and disengageable from said slipper ring to uncouple said slipper ring from said fixed bearing surface and cause said sprags to rock diagonally against the bearing surface of the slipper ring and the fixed bearing surface thereby applying a radial force to said slipper ring.

3. The clutch of claim 1, wherein said first shaft is an inner shaft, said second shaft is an outer shaft.

4. The clutch of claim 1, wherein said sprags are symmetrical in a radial direction.

5. The clutch of claim 1, wherein said sprags are non-symmetrical in a radial direction.

6. The clutch of claim 1, wherein said bearing surface of said slipper ring is smooth and said fixed bearing surface is smooth.

7. The clutch of claim 1, wherein said bearing surface of said slipper ring is smooth and said fixed bearing surface is a plurality of concave bearing surfaces.

8. The clutch of claim 1, wherein said bearing surface of said slipper ring is a plurality of concave bearing surfaces and said fixed bearing surface is smooth.

9. The clutch of claim 1, wherein said bearing surface of said slipper ring is a plurality of concave surfaces, said fixed bearing surface is a plurality of concave bearing surfaces, one of each of said concave bearing surfaces of said slipper ring radially oppose one of each of said concave bearing surfaces of said fixed bearing surface to form pockets, and one of each of said sprags is housed in one of each of said pockets.

10. The clutch of claim 1, wherein said fixed bearing surface is a second radial surface of a fixed cylindrical ring, said fixed ring having a first radial surface fixed to said first shaft.
